(19) United States
(12) Patent Application Publication
(10) Pub. No.: US 2021/0400252 A1
(43) Pub. Date: Dec. 23, 2021

(54) IMAGING METHOD, IMAGING SYSTEM, MANUFACTURING SYSTEM, AND METHOD FOR MANUFACTURING A PRODUCT

(71) Applicant: CANON KABUSHIKI KAISHA, Tokyo (JP)

(72) Inventors: Keita Dan, Tokyo (JP); Hiroto Mizohana, Tokyo (JP); Kenkichi Yamamoto, Tokyo (JP); Kei Watanabe, Tokyo (JP)

(21) Appl. No.: 17/349,527

(22) Filed: Jun. 16, 2021

(30) Foreign Application Priority Data
Jun. 23, 2020 (JP) 2020-107619

(51) Int. Cl. H04N 13/254; H04N 13/239; B25J 19/02

(52) U.S. Cl. CPC H04N 13/254; B25J 19/023; H04N 13/239

(57) ABSTRACT

An imaging system includes a plurality of cameras, and a controller, wherein the controller detects synchronous deviation of image capturing timing of the plurality of cameras by using images respectively captured by the plurality of cameras.

### BACKGROUND

### Field of the Disclosure

The present disclosure relates to an imaging method and an imaging system that synchronize image capturing timing of a plurality of cameras and capture images of an object by the plurality of cameras, and to a manufacturing system and a method for manufacturing a product using the imaging method or the imaging system.

### Description of the Related Art

In recent years, in manufacturing lines of industrial products or the like, assembly operation is performed by assembly manufacturing apparatuses including robot apparatuses instead of manual assembly operation.

In such manufacturing systems, in some cases, a camera and an image processing apparatus for two-dimensional or three-dimensional measurement of a workpiece are used for performing measurement or inspection of the workpiece required for assembly operation. For example, in the case where information in a depth direction is required for the measurement or inspection, a method of performing three-dimensional measurement of an object by the principle of triangulation by using a stereo camera including two or more cameras is used. In three-dimensional measurement of this kind, difference in the position of the object between a plurality of images captured by a plurality of cameras, that is, parallax is calculated, and three-dimensional information is obtained by converting this parallax into a depth amount.

In three-dimensional measurement of this kind, in some cases, a workpiece needs to be measured with high precision while the camera or the workpiece is relatively moving or relatively vibrating. In such a case, when there is a difference in the image capturing time between a plurality of cameras constituting the stereo camera, the position of the object varies in the images captured by the cameras, and therefore the parallax cannot be calculated accurately. In this case, the three-dimensional information such as depth cannot be obtained accurately. Therefore, the image capturing timing needs to be accurately synchronized such that there is no time difference between the plurality of cameras.

As disclosed in Japanese Patent Laid-Open No. 2011-239379, conventionally, a configuration in which one camera includes a communication portion for controlling another camera for matching the image capturing timing of a plurality of cameras constituting a stereo camera is known. Such a configuration allows outputting an image capturing instruction from one camera to another camera at an arbitrary timing, and thus reducing the image capturing time difference between the cameras. In addition, as disclosed in Japanese Patent Laid-Open No. 2018-007031, a configuration in which each of the plurality of cameras constituting the stereo camera has a function of storing an image-captured time and an image in association with each other and images captured at almost the same time by one camera and another camera used for measurement are selected on the basis of the image-captured time is also known. Further, as disclosed in Japanese Patent Laid-Open No. 2014-175931, a configuration in which synchronized image capturing is performed by a plurality of cameras by using strobe light is also known.

In the configuration of Japanese Patent Laid-Open No. 2011-239379, each of the plurality of cameras constituting the stereo camera needs to have a communication portion for communicating a trigger signal. As a result of this, the size and cost of each camera increase, and a stereo camera cannot be installed in some environments in which the distance between cameras is large or in which it is difficult to provide wiring between the cameras.

In addition, in the configuration of Japanese Patent Laid-Open No. 2018-007031, each camera needs to have a function of storing an image-captured time and an image in association with each other. As a result of this, the system becomes more complicated and expensive, and the image-captured time cannot be precisely matched between the cameras in the case where the image capturing start time or image capturing periods of the cameras are different.

### SUMMARY

In view of the issues described above, embodiments of the present disclosure detect synchronous deviation of image capturing timing of a plurality of cameras.

According to embodiments of the disclosure, an imaging system includes a plurality of cameras, and a controller, wherein the controller detects synchronous deviation of image capturing timing of the plurality of cameras by using images respectively captured by the plurality of cameras.

According to the configuration described above, synchronous deviation of image capturing timing of a plurality of cameras can be detected.

Further features of the present disclosure will become apparent from the following description of exemplary embodiments with reference to the attached drawings.

### BRIEF DESCRIPTION OF THE DRAWINGS

FIGS. 1A and 1B are explanatory diagrams illustrating a configuration of an imaging system including a plurality of cameras.

FIG. 2 is an explanatory diagram illustrating an apparatus configuration of a monocular camera of FIGS. 1A and 1B.

FIG. 3 is a state transition diagram illustrating a state change of an image sensor of FIG. 2.

FIG. 4 is a flowchart illustrating a method for detecting synchronous deviation in a first embodiment.

FIG. 5 is an explanatory diagram illustrating output of monocular cameras of the first embodiment in timeline.

FIG. 6 is a flowchart illustrating a method of synchronization in the first embodiment.

FIG. 7 is an explanatory diagram illustrating a configuration for synchronized image capturing in a second embodiment.

FIGS. 8A and 8B are explanatory diagrams illustrating images captured by using a rolling shutter in the second embodiment.

FIG. 8C is an explanatory diagram illustrating images captured by using a global shutter.

FIGS. 9A and 9B are explanatory diagrams illustrating a configuration of a plurality of cameras including lights disposed outside view ranges in a third embodiment.

FIGS. 10A and 10B are explanatory diagrams illustrating a configuration of a plurality of cameras including a diffusing plate in the third embodiment.

FIGS. 11A to 11C are explanatory diagrams illustrating a configuration of an imaging system including recursion reflection marks in a fourth embodiment.

FIG. 12 is a flowchart illustrating a method of synchronization in a fifth embodiment.

FIG. 13 is an explanatory diagram illustrating a configuration of an imaging system including three cameras in a sixth embodiment.

FIG. 14 is a flowchart illustrating a method of camera switching in the sixth embodiment.

FIG. 15 is an explanatory diagram illustrating an example of a control system used as a controller of an imaging system.

### DESCRIPTION OF THE EMBODIMENTS

Embodiments of the present disclosure will be described below with reference to attached drawings. To be noted, the configurations described below are just examples, and for example, details thereof can be appropriately modified by one skilled in the art within the gist of the present disclosure. In addition, numerical values mentioned in the embodiments are merely examples of referential values.

### First Embodiment

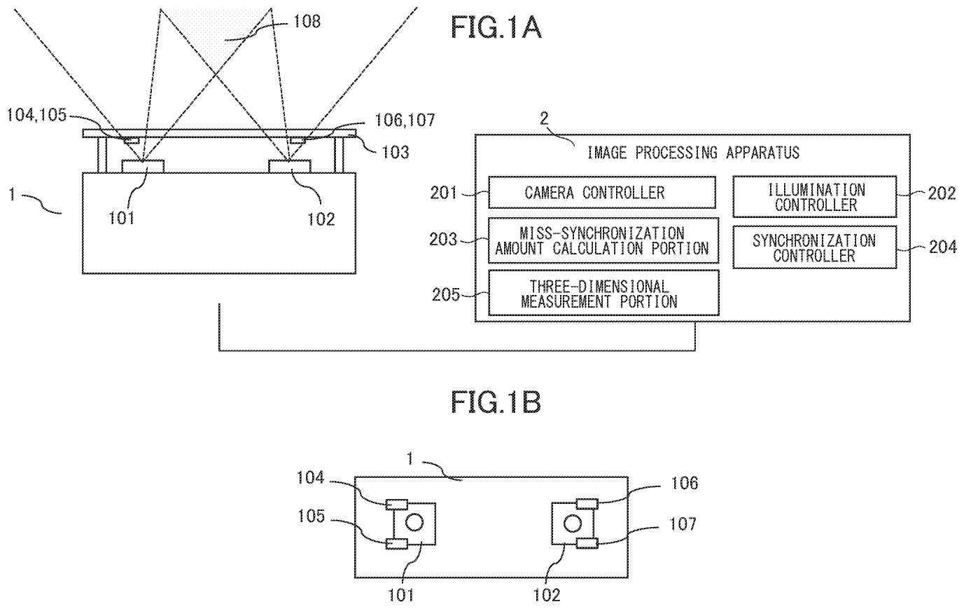

FIG. 1A illustrates a configuration of an imaging system including a stereo camera constituted by a plurality of cameras in the present embodiment. In the imaging system of FIG. 1A, a stereo camera 1 is connected to an image processing apparatus 2. A connection cable between the stereo camera 1 and the image processing apparatus 2 constitutes a communication interface between the two, and includes a power supply line, a communication line for communicating captured image data, an input output line: IO line used for communication control and the like, and so forth. Among these, the communication interface can be based on, for example, a standard such as universal serial bus: USB. The stereo camera 1 includes monocular cameras 101 and 102 arranged such that respective imaging optical axes thereof are separated from each other by an appropriate base line length. Captured image data obtained by the monocular cameras 101 and 102 of the stereo camera 1 can be transmitted to the image processing apparatus 2 via the communication interface described above. In addition, image capturing parameters, which are setting information for image capturing, can be controlled in accordance with setting commands or the like received from the image processing apparatus 2 connected to the stereo camera 1 via the communication interface described above. These image capturing parameters include exposure time, gain, image size, and so forth. In addition, the stereo camera 1 can control light emitting timing of synchronous deviation detection lights 104 to 107 provided in the stereo camera 1 as light-emitting members for detection of synchronous deviation (miss-synchronization) via the IO line of the communication interface described above.

In the present embodiment, the stereo camera 1 is used for measuring three-dimensional information of an object. For example, the stereo camera 1 is disposed in a manufacturing line that manufactures a product, along with manufacturing apparatuses such as a robot apparatus and a robot controller that controls the robot apparatus. In such a configuration, the robot controller can control the robot apparatus on the basis of results of three-dimensional measurement of an object such as a workpiece obtained by the stereo camera 1. To be noted, the stereo camera 1 of the present embodiment is merely an example of a member constituting an imaging system including a plurality of cameras. For example, image capturing control described below can be performed by an arbitrary imaging system that performs synchronized image capturing by a plurality of cameras for some purpose. Examples of the imaging system constituted by a plurality of cameras to which image capturing control of the present embodiment can be applied include a multi-viewpoint camera for capturing a free-viewpoint moving image.

As described above, the stereo camera 1 of FIG. 1A includes the monocular cameras 101 and 102 arranged such that the imaging optical axes thereof are separated from each other by a predetermined base line length. In the present embodiment, an illumination board 103 is disposed on the front side of the monocular cameras 101 and 102, and the synchronous deviation detection lights 104 to 107 are provided on the illumination board 103. The synchronous deviation detection lights 104 to 107 constitute an illumination apparatus that radiates, at the same light emitting timing, illumination light under which the monocular cameras 101 and 102 can capture images.

In the present embodiment, the synchronous deviation detection lights 104 to 107 are disposed outside a common view range 108 of the monocular cameras 101 and 102. According to such a configuration, image capturing can be performed without narrowing the common view range 108, which is a spatial region in which three-dimensional measurement can be performed, by the synchronous deviation detection lights 104 to 107.

In addition, the synchronous deviation detection lights 104 and 105 are disposed inside an individual view range of the monocular camera 101, and the synchronous deviation detection lights 106 and 107 are disposed inside an individual view range of the monocular camera 102. According to such a configuration, light emitted from the synchronous deviation detection lights 104 to 107 is necessarily incident on the monocular cameras 101 and 102.

FIG. 1B illustrates a layout of the synchronous deviation detection lights. In FIG. 1B, the upper side and the lower side of the drawing respectively correspond to the upper side and the lower side of the stereo camera 1. As illustrated in FIG. 1B, the synchronous deviation detection lights 104 and 106 are disposed on the upper side of the monocular cameras 101 and 102, and the synchronous deviation detection lights 105 and 107 are disposed on the lower side of the monocular cameras 101 and 102. The synchronous deviation detection lights 104 and 106 are connected to a driving power line in parallel, and light sources thereof are driven in synchronization so as to emit light at the same timing without being delayed from each other. Similarly, the synchronous deviation detection lights 105 and 107 are connected to a driving power line in parallel, and light sources thereof are driven in synchronization so as to emit light at the same timing without being delayed from each other.

An unillustrated light used for three-dimensional measurement is disposed on the front surface of the illumination board 103. As this light for three-dimensional measurement, a light corresponding to the measurement method such as a pattern floodlight can be provided. In such a configuration as described above, a driving board dedicated to the synchronous deviation detection lights 104 to 107 does not have to be provided, and thus the size of the stereo camera 1 can be reduced.

The image processing apparatus 2 illustrated in FIG. 1A may be constituted by, for example, hardware such as a central processing unit: CPU or a field-programmable gate array: FPGA that performs calculation, a memory portion constituted by a read-only memory: ROM and a random access memory: RAM, and an interface portion: I/F portion that communicates with the outside. In FIG. 1A, the image processing apparatus 2 is illustrated as functional blocks 201 to 205. To be noted, the image processing apparatus 2 of the present embodiment also has an image capturing control function of the stereo camera 1 as will be described later, and may be conceptually also considered as a controller that performs image capturing control via image processing.

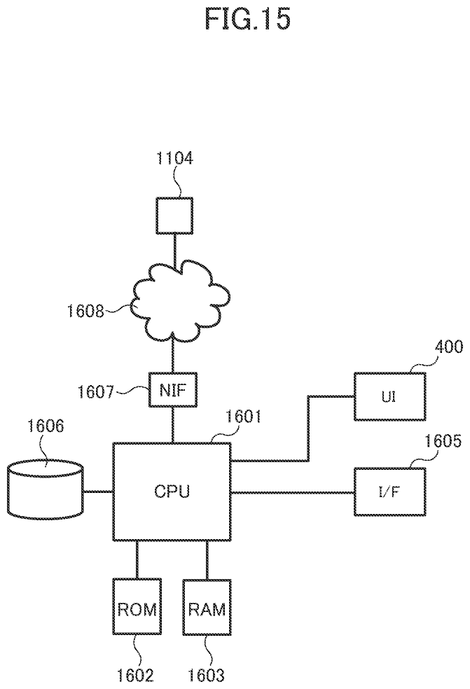

Here, an example of a specific hardware configuration of the control system constituting the image processing apparatus 2 of FIG. 1A will be described with reference to FIG. 15. In the configuration of FIG. 15, each functional block constituting the image processing apparatus 2 illustrated in FIG. 1A is realized by a CPU 1601 and peripheral hardware thereof, or software executed by the CPU 1601. A storage portion used for image processing or image capturing control is constituted by storage areas of a ROM 1602, a RAM 1603, an external storage device 1606 such as a hard disk drive: HDD, and so forth.

The control system of FIG. 15 includes the CPU 1601 as a main control unit, and the ROM 1602 and the RAM 1603 as storage devices. The ROM 1602 can store control programs and constant information for the CPU 1601 to realize a control processing procedure of the present embodiment. In addition, the RAM 1603 is used as a work area of the CPU 1601 or the like when executing the control procedure. In addition, the control system of FIG. 15 is connected to the external storage device 1606. The external storage device 1606 is not necessarily required for implementing embodiments of the present disclosure, and can be constituted by an HDD, a solid state drive: SSD, an external storage device of another system that is network-mounted, or the like.

A control program for the CPU 1601 to realize the control of the present embodiment is stored in a storage portion such as the external storage device 1606 or an electrically erasable programmable read-only memory: EEPROM region of the ROM 1602. In this case, the control program for the CPU 1601 to realize the control procedure of the present embodiment can be supplied to each storage portion described above via the network interface 1607 and updated to a new or different program. Alternatively, the control program for the CPU 1601 to realize the control procedure that will be described later can be supplied to each storage portion described above via storage media such as various magnetic disks, optical disks, and flash memories, and drive devices thereof, and can be thus updated. Various storage media, storage portions, and storage devices storing the control program for the CPU 1601 to realize the control procedure of the present embodiment serve as computer-readable recording media storing a control procedure of the present embodiment.

A network interface 1607 can be provided in accordance with, for example, a wired communication standard such as IEEE 802.3, or a wireless communication standard such as IEEE 802.11 or IEEE 802.15. The CPU 1601 can communicate with another device 1104 via the network interface 1607 and the network 1608. For example, in the case where the stereo camera 1 is connected to the network 1608, for example, the stereo camera 1 serves as the other device 1104. In the case where the stereo camera 1 is connected to the CPU 1601 in accordance with a standard that is different from network connection, an interface 1605 is used. The interface 1605 may be also used for connecting to other peripheral devices.

In addition, a user interface device 400: UT device 400 may be provided in the control system of FIG. 15 if necessary. The user interface device 400 may be, for example, a graphic user interface device: GUI device constituted by a liquid crystal display: LCD, a keyboard, a pointing device such as a mouse, a joystick, or a jog dial, and so forth. The user interface device 400 can be used for notifying a captured image, notifying progress and results of synchronization processing and three-dimensional measurement processing by the cameras that will be described later, and setting image capturing parameters and control constants related to synchronization.

As illustrated in FIG. 1A, the image processing apparatus 2 includes functional blocks of a camera controller 201, an illumination controller 202, a synchronous deviation amount calculation portion 203, a synchronization controller 204, and a three-dimensional measurement portion 205. For example, these functional blocks as controllers may be realized by hardware blocks in an FPGA, or realized by, for example, the CPU 1601 described above loading and executing a program stored in the ROM 1602 or the like.

The outline of the functional blocks 201 to 205 of the image processing apparatus 2 of FIG. 1A will be described below. The camera controller 201 controls the image capturing operation of the monocular cameras 101 and 102. The details of this control will be described when describing the inner configuration of the monocular camera 101 and 102. Here, the outline of each portion will be described.

In the present embodiment, when capturing an image, first, power is supplied to the monocular cameras 101 and 102, and the camera controller 201 transmits an initialization instruction. When the initialization of the monocular cameras 101 and 102 is finished, an instruction to change the image capturing parameters is transmitted to the monocular cameras 101 and 102. In some cases, the image capturing parameters include, for example, an exposure time, gain, image size, and focal length or the like depending on the optical system.

When the adjustment of the image capturing parameters is completed, the camera controller 201 transmits a moving image output start instruction to cause the monocular cameras 101 and 102 to output moving images. In addition, at this time, the illumination controller 202 determines the driving condition of the light for three-dimensional measurement and the synchronous deviation detection lights 104 to 107 in accordance with the image capturing condition. The camera controller 201 has a function of obtaining still image data by cutting out a still image from moving image data when receiving an instruction to obtain an image from another functional block.

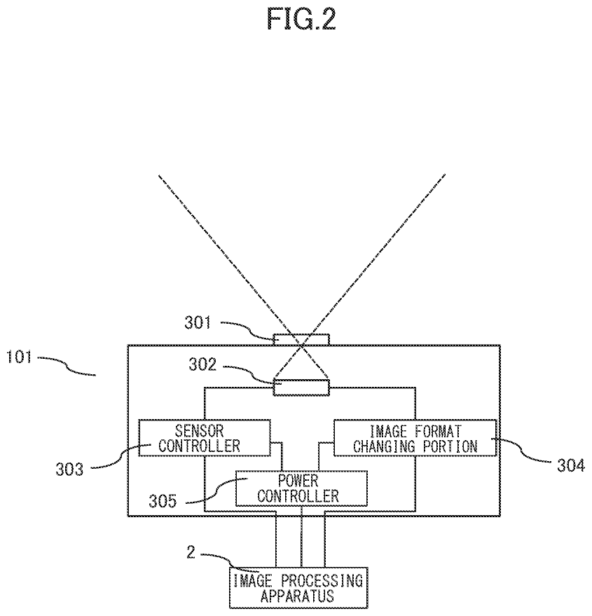

In addition, when the camera controller 201 stops power supply to an image sensor 302 illustrated in FIG. 2, the output of a moving image is stopped. Then, the process described above can be executed again by performing the power supply and initialization described above, and thus the output of a moving image can be resumed. In this manner, the camera controller 201 controls the moving image output start timing.

The illumination controller 202 controls the light emitting timing of the synchronous deviation detection lights 104 to 107. This illumination control is performed by, for example, transmitting pulse width modulation signals: PWM signals to the synchronous deviation detection lights 104 to 107 via the IO line. As described above, the driving power lines of the synchronous deviation detection lights 104 and 106 are electrically connected to each other in the illumination board 103, and therefore synchronized light emission can be performed. Similarly, the synchronous deviation detection lights 105 and 107 are also capable of synchronized light emission. To be noted, for example, a delay time between a time point when a light-on/light-off command is output from the illumination controller 202 and a time point when an illumination light source of interest actually switches on/off is very short. For example, a response time of an illumination light source to drive control is sufficiently shorter than an image capturing control time of the monocular cameras 101 and 102. Examples of the image capturing control time include one-frame time of these cameras such as 1/24 sec, 1/30 sec, and 1/60 sec. That is, the control speed or control time of the synchronous deviation detection lights 104 to 107 is sufficiently higher or shorter than the image capturing control speed or image capturing control time of the moving image.

The synchronous deviation amount calculation portion 203 calculates the synchronous deviation amount between the image capturing timing of the monocular cameras 101 and 102. Details of the method for calculating the synchronous deviation amount will be described later.

The synchronization controller 204 synchronizes the image capturing timing of the monocular cameras 101 and 102 when synchronous deviation is detected by the synchronous deviation amount calculation portion 203. Details of this synchronization will be described later.

The three-dimensional measurement portion 205 performs three-dimensional measurement by using images captured by the monocular cameras 101 and 102 of the stereo camera 1. The three-dimensional measurement portion 205 for the images captured by the monocular cameras 101 and 102 can calculate a distance by the principle of triangulation using a parallax amount obtained by stereo matching processing and internal parameters and external parameters obtained by stereo camera calibration.

In the stereo matching processing described above, for example, an image captured by the monocular camera 101 is set as a reference image, and a pixel corresponding to a pixel in the reference image, that is, a pixel corresponding to the same part of the object as the pixel in the reference image is, by matching, determined in the image captured by the monocular camera 102. As examples of this stereo matching processing, block matching methods such as sum of absolute difference: SAD and sum of squared difference: SSD are known. Publicly known methods of matching processing like these can be also used in the present embodiment.

The internal parameters, external parameters, and the like described above are equivalent to those used in image processing libraries related to (digital) cameras such as OpenCV in terms of concept. The internal parameters indicate optical characteristics such as the focal length and distortion characteristics of the lens, and the external parameters indicate the relative positions and orientations of the two cameras in the stereo camera. The internal parameters and the external parameters can be calculated in advance by an optimization method by capturing a calibration chart whose shape is already known. The internal parameters and the external parameters calculated in advance for the monocular cameras 101 and 102 are, for example, stored in a ROM in the image processing apparatus 2.

To be noted, although description will be given in the present embodiment assuming that the image processing apparatus 2 is an apparatus separate from the stereo camera 1, the image processing apparatus 2 may be incorporated in the stereo camera 1 like a so-called smart camera. According to such a configuration, wiring between the stereo camera 1 and the image processing apparatus 2 is not necessary, and therefore man-hours for installing the system can be reduced greatly.

Next, the inner configuration of the monocular cameras 101 and 102 will be described. The monocular cameras 101 and 102 are relatively small and cheap cameras such as web cameras or module cameras for mobile phones. In the present embodiment, the monocular cameras 101 and 102 are each a product that can be purchased as an individual unit, and the stereo camera 1 is formed by incorporating these cameras in a single casing or a frame. The monocular cameras 101 and 102 are positioned with respect to each other by the casing or frame described above so as to be separated from each other by a predetermined base line length. In the present embodiment, the monocular cameras 101 and 102 do not need a function of synchronizing with an external synchronization signal such as a genlock function, or a time stamp function of outputting an image-captured time. According to the present embodiment, the stereo camera 1 can be formed from units of the monocular cameras 101 and 102, which can be easily obtained and are relatively cheap.

FIG. 2 illustrates an example of the inner configuration of the monocular camera 101. The configuration of the monocular camera 102 is similar to that of the monocular camera 101. The monocular camera 101 has a structure in which a condensing portion 301, an image sensor 302, a sensor controller 303, an image format changing portion 304, and a power controller 305 are integrated.

The condensing portion 301 is a lens, and constitutes an imaging optical system for the condensed light to be incident on the image sensor 302.

The image sensor 302 is, for example, an image sensor of a charge-coupled device: CCD, or a complementary metal oxide semiconductor: CMOS. An image transmitted to the sensor controller 303 is, for example, in a so-called RAW image format conforming to mobile industry processor interface camera serial interface-2: MIPI CSI-2. To be noted, the standard of the image sensor 302 and the output image format are not limited to these, and can be arbitrarily selected by one skilled in the art.

Here, the outline of the functional blocks 303 to 305 of the monocular camera 101 described above will be described. The sensor controller 303, the image format changing portion 304, and the power controller 305 are constituted by an electronic circuit including an FPGA, a memory portion constituted by a ROM and a RAM, and an interface portion: I/F portion that communicates with the outside. These blocks and the image sensor 302 are mutually electrically connected inside the monocular camera 101.

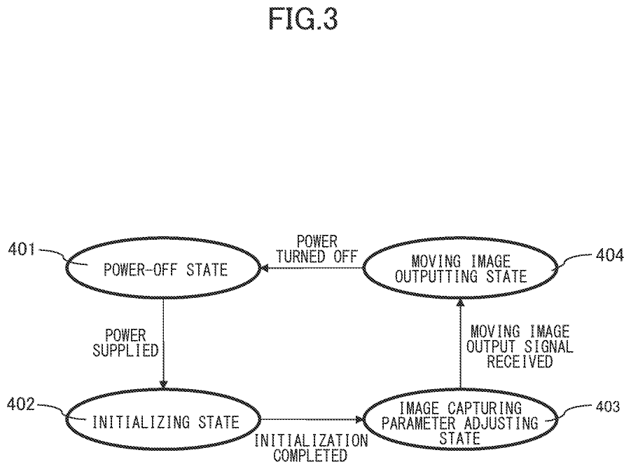

The sensor controller 303 controls the state transition of the image sensor 302 by communicating with the camera controller 201 in the image processing apparatus 2. Here, FIG. 3 illustrates the transition of the operation status of the image sensor 302 of the present embodiment. As illustrated in FIG. 3, the operation status of the image sensor 302 include four states including a power-off state 401, an initializing state 402, an image capturing parameter adjusting state 403, and a moving image outputting state 404. These states will be described below.

The power-off state 401 is a state in which power is not supplied to the image sensor 302. The sensor controller 303 supplies power to the image sensor 302 when a power supply instruction is received from the camera controller 201 in the image processing apparatus 2. When power is supplied to the image sensor 302, the image sensor 302 transitions to the initializing state 402.

The initializing state 402 is a state in which the image sensor 302 is initialized. First, the sensor controller 303 supplies a clock signal to the image sensor 302. The sensor controller 303 transmits an initialization signal to the image sensor 302 when an initialization start instruction is received from the camera controller 201 in the image processing apparatus 2. When the initialization is completed in this manner, it becomes possible for the sensor controller 303 and the image sensor 302 to communicate with each other, and the operation status transitions to the image capturing parameter adjusting state 403.

In addition, the image capturing parameter adjusting state 403 is a state in which the sensor controller 303 can adjust the image capturing parameters of the image sensor 302. Examples of the image capturing parameters include exposure time, gain, and image size. In this state, when the sensor controller 303 receives an instruction to change the image capturing parameters described above from the camera controller 201 of the image processing apparatus 2, the sensor controller 303 transmits, for example, a control command to the image sensor 302 to rewrite a register value in which an image capturing parameter is stored.

When the sensor controller 303 receives a moving image output start instruction from the camera controller 201 of the image processing apparatus 2, the sensor controller 303 transmits a moving image output start signal to the image sensor 302 to switch the image sensor 302 to the moving image outputting state 404.

The moving image outputting state 404 of FIG. 3 is a state in which the image sensor 302 is continuously outputting moving image data to the image format changing portion 304. In this state, when the sensor controller 303 receives a moving image output stopping instruction from the camera controller 201 in the image processing apparatus 2, the sensor controller 303 stops the power supply to the image sensor 302 to stop the output of moving image. As a result of this, the image sensor 302 of the present embodiment transitions to the power-off state 401.

After the monocular camera 101 or 102 has transitioned to the power-off state 401 of FIG. 3, a moving image can be output again by the camera controller 201 in the image processing apparatus 2 causing the image sensor 302 to transition the state again via the sensor controller 303. As described above, the image processing apparatus 2 can control the moving image output start timing or moving image output end timing of the monocular cameras 101 and 102.

A configuration in which the monocular camera 101 or 102 can only transition to the power-off state 401 from the moving image outputting state 404 has been described above. However, in the case where the image sensor 302 has a state transition function from the moving image outputting state 404 to the initializing state 402, the state of the monocular camera 101 or 102 can be switched from the moving image outputting state 404 to the initializing state 402. In the case where the image sensor 302 has a state transition function like this, for example, there is a possibility that the moving image output timing of the monocular cameras 101 and 102 can be changed for synchronization without turning the power off.

In addition, a configuration in which the image sensor 302 of the monocular camera 101 or 102 has an image capturing mode changing function in which output of a moving image is started in the case where a moving image mode is selected, and the output of a moving image is stopped in the case where a still image mode is selected can be also considered. In such a camera configuration, there is a possibility that the moving image output timing of the monocular cameras 101 and 102 can be changed for synchronization without turning the power off, by switching the image capturing mode between the moving image mode and the still image mode.

In the present embodiment, control in which the monocular cameras 101 and 102 are reset by switching the operation status from the moving image outputting state 404 to the power-off state 401 and the moving image output start timing is changed for synchronizing the monocular cameras 101 and 102 will be described. However, the moving image output timing may be changed for synchronization of the monocular cameras 101 and 102 by, for example, using a different state transition function or switching the image capturing mode as described above.

In FIG. 2, a control interface between the image sensor 302 and the sensor controller 303 can be constituted by an IO terminal and an inter-integrated circuit: I2C. In addition, the image format changing portion 304 of the present embodiment has a function of changing the format of an image received from the image sensor 302 from the RAW image format to an image format for transmission to the image processing apparatus 2. Examples of formats supported by the image format changing portion 304 include formats conforming to USB video class: UVC. To be noted, the image format changing portion 304 may support image formats other than UVC.

In addition, the power controller 305 has a function of supplying power to the sensor controller 303 and the image format changing portion 304 when a command to supply power is received from the image processing apparatus 2. According to this command to supply power, the state of the monocular cameras 101 and 102 can be switched from the power-off state 401 to the initializing state 402. The power supply to the image sensor 302 is controlled via the sensor controller 303 as described above.

### Method for Calculating Synchronous Deviation Amount

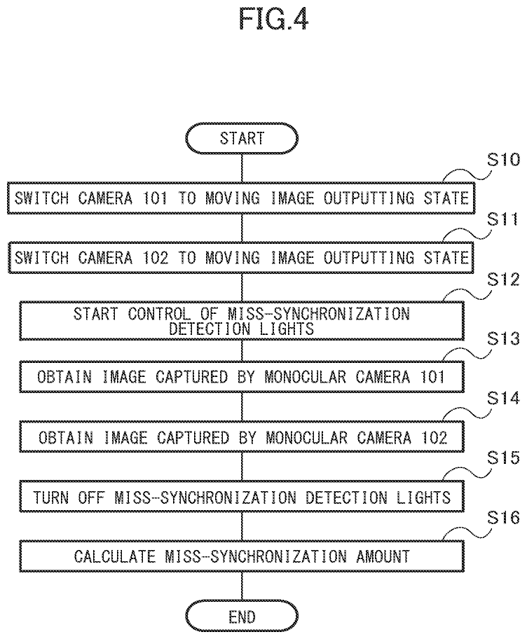

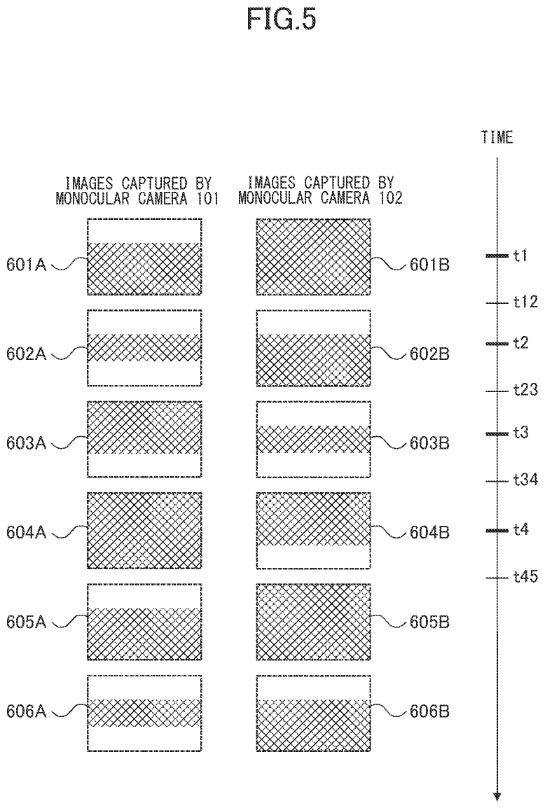

Here, a method for calculating the synchronous deviation amount between the monocular cameras 101 and 102 of the stereo camera 1 in the present embodiment will be described. FIG. 4 illustrates a procedure for detecting synchronous deviation, and FIG. 5 illustrates examples of images output from the monocular cameras 101 and 102 in timeline.

Steps S10 to S15 of FIG. 4 correspond to a light-emitting image-capturing step for synchronous deviation detection in the present embodiment, and step S16 corresponds to an image processing step for synchronous deviation detection in the present embodiment.

In step S10 of FIG. 4, the sensor controller 303 switches the monocular camera 101 to the moving image outputting state 404 on the basis of a moving image output start instruction transmitted from the camera controller 201 of the image processing apparatus 2. Then, the synchronous deviation amount calculation portion 203 instructs the camera controller 201 to transmit a moving image output start instruction to the monocular camera 101. This enables obtaining an image captured by the monocular camera 101 at an arbitrary timing.

In step S11, the sensor controller 303 switches the monocular camera 102 to the moving image outputting state 404 on the basis of the moving image output start instruction transmitted from the camera controller 201 of the image processing apparatus 2. Then, the synchronous deviation amount calculation portion 203 instructs the camera controller 201 to transmit a moving image output start instruction to the monocular camera 102. This enables obtaining an image captured by the monocular camera 102 at an arbitrary timing.

In step S12, control of the synchronous deviation detection lights 104 to 107 is started. As described above, control for turning on/off the synchronous deviation detection lights 104 to 107 is preferably executed at a speed higher than the frame rate of moving images output from the monocular cameras 101 and 102. To be noted, in the present embodiment, a case where the period of the power-on/power-off control of the lights is equal to the frame rate will be described for the sake of simplicity of description. First, in step S12, the synchronous deviation amount calculation portion 203 commands the illumination controller 202 to simultaneously flash the synchronous deviation detection lights 104 and 106 after the elapse of a certain time Δt [ms]. Then, similarly, after the elapse of another certain time Δt [ms], the illumination controller 202 simultaneously flashes the synchronous deviation detection lights 105 and 107. Then, similarly, after the elapse of another certain time Δt [ms], the illumination controller 202 simultaneously flashes the synchronous deviation detection lights 104 and 106. Then, similarly, after the elapse of another certain time Δt [ms], the illumination controller 202 simultaneously flashes the synchronous deviation detection lights 105 and 107. This processing of alternately flashing the pair of synchronous deviation detection lights 104 and 106 and the pair of synchronous deviation detection lights 105 and 107 at an interval of the certain time Δt [ms] is repeatedly performed until step S15 during processing of obtaining images from the monocular cameras 101 and 102 in steps S13 and S14.

In step S13, an image captured by the monocular camera 101 is obtained. At this time, the synchronous deviation amount calculation portion 203 transmits an image obtaining instruction to the camera controller 201, cuts out a still image from moving image data transmitted from the monocular camera 101, and thus obtains still image data thereof. In step S14, an image of the monocular camera 102 is obtained. At this time, the synchronous deviation amount calculation portion 203 transmits an image obtaining instruction to the camera controller 201, cuts out a still image from moving image data transmitted from the monocular camera 102, and thus obtains still image data thereof.

In step S15, the synchronous deviation amount calculation portion 203 commands the illumination controller 202 to turn off the synchronous deviation detection lights 104 to 107. Then, in step S16, the synchronous deviation amount calculation portion 203 calculates a synchronous deviation amount from the images obtained in steps S13 and S14, for example, as follows.

In FIG. 5, 601A to 606A denote images output from the monocular camera 101 at respective time points. In FIG. 5, time points after the elapse of Δt from each other starting from a time point t1 are sequentially denoted by t2, t3, t4 . . . That is, the time point t2 is t1+Δt, the time point t3 is t2+Δt, and the time point t4 is t3+Δt.

In FIG. 5, the image 601A is an image captured at the time point t1 while the synchronous deviation detection lights 104 and 106 are on. The image 602A is an image captured at the time point t2 while the synchronous deviation detection lights 104 to 107 are on. The image 603A is an image captured at the time point t3 while the synchronous deviation detection lights 105 and 107 are on. The image 604A is an image captured at the time point t4 while the synchronous deviation detection lights 104 to 107 are off. After this time point, images 605A, 606A . . . similar to the images 601A to 604A are repeatedly output. Meanwhile, images 601B to 606B are images output from the monocular camera 102 at respective time points similarly to the monocular camera 101.

The synchronous deviation detection lights 104 to 107 are all on at a time point t12, and only the synchronous deviation detection lights 105 and 107 are on at a time point t23. Further, the synchronous deviation detection lights 104 to 107 are all on at a time point t34, and only the synchronous deviation detection lights 104 and 106 are on at a time point t45. This illumination pattern is repeated. In this example, the intervals between the time points t12, t23, t34, and t45 are also Δt, and the difference between the time point t1 and the time point t12 is Δt/2.

For example, here, it is assumed that the images obtained in steps S13 and S14 are the images 603A and 603B obtained at the time point t3. In this case, the time point at which the image 603A is actually captured is between the time point t23 and the time point t34, and the time point at which the image 603B is captured is actually between the time point t12 and the time point t23. In this example, the detected synchronous deviation amount between the monocular cameras 101 and 102 is equal to or smaller than Δt. Therefore, for example, the synchronous deviation amount between the monocular cameras 101 and 102 can be calculated by image processing of searching for similar image patterns such as brightness patterns between the images respectively captured by the monocular cameras 101 and 102.

In the present embodiment, a case where the interval Δt at which power-on and power-off of the synchronous deviation detection lights 104 to 107 are switched is equal to an image capturing interval Δt has been described. If the illumination switching interval is shortened, the synchronous deviation can be detected with higher precision. For example, if the illumination switching interval is Δt/2, the synchronous deviation amount can be detected at a resolution higher than Δt.

However, if the illumination switching interval is too short, in some cases the synchronous deviation cannot be detected accurately. For example, a case where the power-on and power-off of the lights are switched between four levels including a level where the lights in the upper portion and the lower portion are all on, a level where only the lights in the upper portion are on, a level where only the lights in the lower portion are on, and a level where the lights in the upper portion and the lights in the lower portion are all off as in the present embodiment will be described. In this case, when the illumination condition is switched at an interval shorter than Δt/4, images of the same illumination condition are captured by the monocular cameras 101 and 102 in the case where the synchronous deviation amount is Δt. As described above, the illumination switching interval is preferably longer than a value obtained by dividing the image capturing interval Δt by the number of levels of the illumination condition.

To be noted, the interval Δt at which the power-on and power-off of the synchronous deviation detection lights 104 to 107 are switched may be obtained by actual measurement in advance. For example, before calculating the synchronous deviation amount, the synchronous deviation detection lights 104 to 107 are turned on only once after the monocular cameras 101 and 102 are switched to the moving image outputting state. Then, the interval Δt may be determined on the basis of the difference between a time point when an image output from the monocular camera 101 is switched from an image where all the lights are off like in the image 604A to an image where the lights are on like in the image 602A and a time point when an image output from the monocular camera 101 is switched from an image where all the lights are off to an image where the lights are on.

In addition, normally, distortion of a captured image is greater in a peripheral portion of the image, and therefore the peripheral portion is often not used for image processing such as three-dimensional measurement. In addition, a portion not corresponding to a common view range of the monocular cameras 101 and 102 is not used in three-dimensional measurement that will be described later. That is, in the present embodiment, the synchronous deviation detection lights 104 to 107 are disposed so as to affect only the portion described above that is not to be used in image processing. Therefore, according to the illumination control described above, the synchronous deviation can be detected all the time even during the three-dimensional measurement that will be described later.

In addition, although the four synchronous deviation detection lights 104 to 107 are used in the present embodiment, a configuration in which only one synchronous deviation detection light is provided may be employed as long as the synchronous deviation detection light is disposed at such a position as to influence both the monocular cameras 101 and 102 simultaneously. Alternatively, a configuration in which the light emitting mode of the synchronous deviation detection lights such as the emission color or emission pattern varies such that each synchronous deviation detection light can be identified may be employed. In this case, for example, a synchronous deviation detection light that is on can be identified from a captured image. By utilizing this, for example, the number of the synchronous deviation detection lights may be increased. According to such a configuration, there is a possibility that the synchronous deviation amount can be calculated with higher precision.

### Synchronization

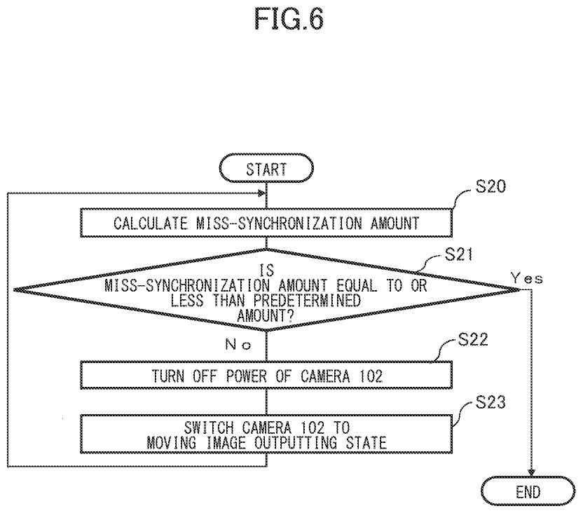

Here, an example of a method of synchronizing the monocular cameras 101 and 102 on the basis of the synchronous deviation amount detected as described above will be described with reference to FIG. 6. FIG. 6 illustrates a procedure of synchronization.

In step S20 of FIG. 6, the synchronous deviation amount is calculated as described above. In step S21, whether or not the calculated synchronous deviation amount is equal to or smaller than a predetermined value is determined. In the case where the calculated synchronous deviation amount is equal to or smaller than the predetermined value, that is, in the case where the result of step S21 is YES, three-dimensional measurement processing is performed subsequently to the processing illustrated in FIG. 6. In addition, in the case where the calculated synchronous deviation amount is larger than the predetermined value, that is, in the case where the result of step S21 is NO, the process proceeds to step S22.

In step S22, as processing for synchronization, the power of the monocular camera 102 is turned off. This synchronization control utilizes the state transition mode of the monocular cameras 101 and 102 illustrated in FIG. 3.

Subsequently to step S22, in step S23, one of the miss-synchronized monocular cameras, for example, the monocular camera 102 is switched to the moving image outputting state 404 illustrated in FIG. 3. As a result of this, the monocular camera 102 transitions from the power-off state 401 to the moving image outputting state 404 through the initializing state 402 and the image capturing parameter adjusting state 403 as described with reference to FIG. 3. After step S23, the process proceeds to step S20. At this time, the time that elapses before the monocular camera 102 reaches the moving image outputting state 404 is determined by a process that is random to some extent. Therefore, by repeating the processing of steps S20 to S23 described above a plurality of times, the synchronous deviation amount eventually becomes equal to or smaller than the predetermined value. Therefore, the difference between time points at which two images to be used for image processing such as three-dimensional measurement are respectively captured is smaller than the difference between time points at which two images used for image processing for detecting synchronous deviation are respectively captured.

As described above, in the present embodiment, the synchronous deviation amount between the monocular cameras 101 and 102 can be detected from brightness patterns in images captured by the monocular cameras 101 and 102, by using a pattern in which the synchronous deviation detection lights are turned on at predetermined intervals, that is, by using an illumination light pattern. Then, in the case where the synchronous deviation amount is larger than a predetermined value, the monocular cameras 101 and 102 are synchronized through a relatively random process by turning off and initializing one of the monocular cameras 101 and 102.

In the present embodiment, the synchronous deviation detection lights 104 to 107 are disposed at such positions as to not affect the three-dimensional measurement, and therefore the synchronous deviation detection can be performed also during the three-dimensional measurement. Further, the synchronization processing described above can be performed while, for example, the stereo camera 1 is not performing measurement processing. In the present embodiment, according to such control, the synchronization between the monocular cameras 101 and 102 constituting the stereo camera 1 can be performed without extending the measurement time for the three-dimensional measurement.

### Second Embodiment

In the first embodiment described above, the synchronous deviation detection lights 104 to 107 are included in the stereo camera 1. However, to simplify the configuration of the stereo camera 1 and reduce the cost, size, and weight, a configuration in which the synchronous deviation detection is performed by using an external light as in the present embodiment can be also considered.

In the description below, part of the configuration of the hardware and control system different from the first embodiment will be illustrated and described, and detailed description of part similar to the first embodiment will be omitted assuming that the part can be configured in a similar manner to that described above and can have a similar effect.

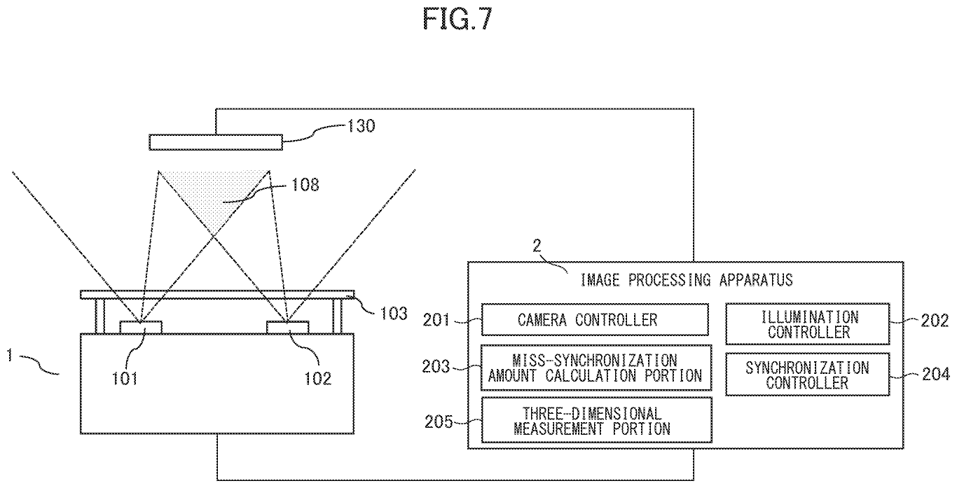

In the present embodiment, as illustrated in FIG. 7, an external light 130 is disposed within a common view range 108 of the monocular cameras 101 and 102. In the present embodiment, the external light 130 is used as a synchronous deviation detection light. The external light 130 may be a light dedicated to synchronous deviation detection, or a light that is also used for other image processing or the like.

In addition, also in the present embodiment, control time of the external light 130 is sufficiently shorter than one-frame time in moving image capturing control of the monocular cameras 101 and 102 such as 1/24 sec, 1/30 sec, or 1/60 sec. That is, the control speed or control time of the external light 130 is sufficiently higher or shorter than the image capturing control speed or image capturing control time of the moving image. Also in the present embodiment, the control procedure for synchronous deviation detection and synchronization are approximately the same as that described with reference to FIGS. 4 and 6.

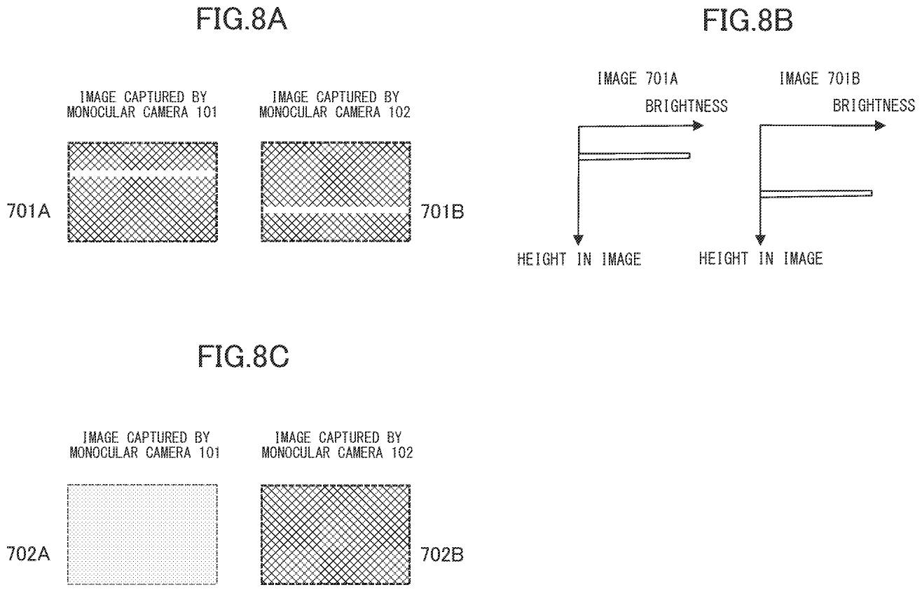

However, the method for synchronous deviation detection is slightly different between a case where a rolling shutter is used in the monocular cameras 101 and 102 and a case where a global shutter is used in the monocular cameras 101 and 102. The synchronous deviation detection method of the present embodiment will be described below with reference to FIGS. 8A to 8C.

FIG. 8A illustrates an example of images captured by using the external light 130 in the case where a rolling shutter is used in the monocular cameras 101 and 102. FIG. 8B illustrates graphs indicating an example of average values of brightness with respect to the position in the height direction in the images captured in the condition of FIG. 8A.

As described above, the synchronous deviation detection control can be performed in substantially the same manner as in the first embodiment illustrated in FIG. 4. In step S12 of FIG. 4, the external light 130 is turned on for a certain time. This illumination for a certain time is shorter than the one-frame time of the monocular cameras 101 and 102. The external light 130 is turned off after a certain time after being turned on. In the present embodiment, step S15 of FIG. 4 is not necessary.

In step S13, an image captured by the monocular camera 101 is obtained. In this step, an image similar to an image 701A illustrated in FIG. 8A is obtained. Subsequently, in step S14, an image captured by the monocular camera 102 is obtained. In this step, an image similar to an image 701B illustrated in FIG. 8A is obtained. In the case where a rolling shutter is used in the monocular cameras 101 and 102, the light from the external light 130 appears in a linear shape in the captured images as illustrated in FIG. 8A. This is because exposure of each pixel or each image capturing line of the cameras is sequentially turned on in the case where a rolling shutter is used.

In step S16, the synchronous deviation amount is calculated as follows from images captured as illustrated in FIG. 8A. Here, for example, the frame rate (fps) of the monocular cameras 101 and 102 is denoted by F, and the height and width of an image are respectively denoted by H and W.

The average value of brightness of pixels at the same height in the image 701A obtained by the monocular camera 101 is calculated for each height in the image 701A, and the height in the image 701A at which the brightness is the highest is denoted by H1. Here, the brightness is represented by 256 gradations from 0 to 255. In the case where the average value of brightness of pixels at the same height in the image 701B obtained by the monocular camera 102 is calculated for each height in the image 701B and the height in the image 701B at which the brightness is the highest is denoted by H2, the synchronous deviation amount can be calculated by (H2−H1)/(F×H).

That is, in the present embodiment, in the case where a rolling shutter is used in the monocular cameras 101 and 102, the synchronous deviation amount between the monocular cameras 101 and 102 is calculated on the basis of the position of a light image of the external light 130 used as a synchronous deviation detection light in captured images.

To be noted, in the description above, in the case where a rolling shutter is used in the monocular cameras 101 and 102, the average values of brightness of pixels at the same height in obtained images are obtained for each height in the obtained images, and height in the image at which the brightness is the highest is used. However, the median points of brightness in the height direction in the images may be used after calculating the average values of brightness of pixels at the same height for each height in the images.

In addition, in the present embodiment, in the case where a global shutter is used in the monocular cameras 101 and 102, the synchronous deviation detection can be performed by the following calculation. FIG. 8C illustrates images captured in the case where a global shutter is used in the monocular cameras 101 and 102.

The synchronous deviation detection procedure in this example is substantially the same as in the first embodiment illustrated in FIG. 4. In step S12, the external light 130 is turned on for a certain time shorter than the one-frame time, and is then turned off. Also in this example, step S15 of FIG. 4 is not necessary. In step S13, an image captured by the monocular camera 101 is obtained. An image like an image 702A is obtained in step S13. In step S14, an image captured by the monocular camera 102 is obtained. An image like an image 702B is obtained in step S14.

In the case where a global shutter is used in the monocular cameras 101 and 102, control is performed such that all pixels or image capturing lines are exposed to light at the same time. Therefore, in the case where the relationship between the lighting time of the external light 130 and the image capturing timing is different between the monocular cameras 101 and 102, that is, in the case where the monocular cameras 101 and 102 are miss-synchronized, the amount of light in the pixels is different as illustrated in FIG. 8C.

In the case where a global shutter is used in the monocular cameras 101 and 102, in step S16, the synchronous deviation amount is calculated as follows. Here, the frame rate (fps) of the monocular cameras 101 and 102 is denoted by F, and the average brightness of all pixels in each image captured by the monocular camera 101 or 102 while the external light 130 is on the whole time is denoted by Lmax. In addition, the average brightness of all pixels in each image captured by the monocular camera 101 or 102 while the external light 130 is off the whole time is denoted by Lmin. Lmax is preferably smaller than 255 in the case of 8-bit quantization. Then, in step S12, in the case where the time t in which the external light 130 is on is 1/F, the average brightness of all pixels in the image 702A is La, and the average brightness of all pixels in an image 702B is Lb, the synchronous deviation amount can be calculated by (La−Lb)/(Lmax−Lmin).

That is, in the present embodiment, in the case where a global shutter is used in the monocular cameras 101 and 102, the synchronous deviation amount between the monocular cameras 101 and 102 is calculated on the basis of the ratio of brightness or density between images of the external light 130 serving as synchronous deviation detection lights captured thereby.

As described above, according to the present embodiment, the synchronous deviation amount between the monocular cameras 101 and 102 can be calculated on the basis of the position of light images of a synchronous deviation detection light and brightness or average brightness of images.

### Third Embodiment

In the first embodiment, the synchronous deviation detection lights 104 and 105 are disposed in the individual view range of the monocular camera 101, and the synchronous deviation detection lights 106 and 107 are disposed in the individual view range of the monocular camera 102. However, since the distance between the monocular cameras 101 and 102 and the synchronous deviation detection lights 104 to 107 is short, the individual view ranges of the monocular cameras 101 and 102 excluding the common view range 108 are not so large. Therefore, there is a possibility that an operation of finely adjusting the installation positions of the synchronous deviation detection lights 104 to 107 is difficult.

In addition, since the synchronous deviation detection lights 104 and 105 are disposed in the individual view range of the monocular camera 101 and the synchronous deviation detection lights 106 and 107 are disposed in the individual view range of the monocular camera 102, there is an issue that the measurement range is narrow in the case where, for example, measurement is performed by two-dimensional image processing using only images captured by the monocular camera 101.

In the present embodiment, in consideration of the above, a different layout of the synchronous deviation detection lights 104 to 107 will be discussed.

In the description below, part of the configuration of the hardware and control system different from the first embodiment will be illustrated and described, and detailed description of part similar to the first embodiment will be omitted assuming that the part can be configured in a similar manner as described above and can have a similar effect.

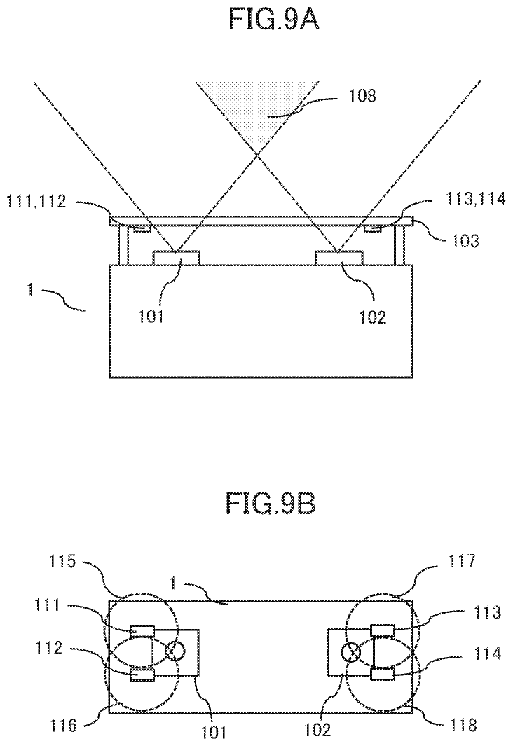

In the present embodiment, as illustrated in FIG. 9A, synchronous deviation detection lights 111 to 114 are disposed at positions on the illumination board 103 outside the view ranges of the monocular cameras 101 and 102. In this case, as illustrated in FIG. 9B, the synchronous deviation detection lights 111 and 113 are disposed on the upper side of the monocular cameras 101 and 102, and the synchronous deviation detection lights 112 and 114 are disposed on the lower side of the monocular cameras 101 and 102. The driving power lines of the synchronous deviation detection lights 111 and 113 are electrically connected to each other, and the synchronous deviation detection lights 111 and 113 can be turned on and off simultaneously. Similarly, the driving power lines of the synchronous deviation detection lights 112 and 114 are electrically connected to each other, and the synchronous deviation detection lights 112 and 114 can be turned on and off simultaneously.

As illustrated in FIG. 9B, a lens of the monocular camera 101 is included in irradiation ranges 115 and 116 of the synchronous deviation detection lights 111 and 112, and a lens of the monocular camera 102 is included in irradiation ranges 117 and 118 of the synchronous deviation detection lights 113 and 114.

According to such settings of the layout and irradiation ranges of the lights, scattering of light, that is, so-called stray light occurs in the lens barrels of the monocular cameras 101 and 102 and the like when intense light is radiated to the lenses from the synchronous deviation detection lights 111 to 114. In the case where an image of the monocular cameras 101 and 102 is captured in a state in which the synchronous deviation detection lights 111 to 114 are on, an image in which a lens flare appears can be captured. That is, for example, in the case where an image is captured by the monocular camera 101 while the synchronous deviation detection light 111 is on, an image only an upper-right portion thereof where the synchronous deviation detection light 111 is positioned is bright can be captured.

As described above, in the present embodiment, the synchronous deviation detection lights 111 to 114 are disposed outside the fields of view of the monocular cameras 101 and 102 while the irradiation ranges thereof cover part of incident openings of the imaging optical systems of the monocular cameras 101 and 102. As a result of this, an image of incident light from each light can be captured by using the stray light in the lens barrel.

In the present embodiment, the brightness of partial regions of images is controlled by the on/off of the synchronous deviation detection lights 111 to 114. By using this, the synchronous deviation amount can be detected by the method of step S16 illustrated in FIG. 4 described in the first embodiment.

In the present embodiment, since the synchronous deviation detection lights 111 to 114 are outside the view ranges of the monocular cameras 101 and 102, the monocular cameras 101 and 102 can capture images without any part of the view ranges thereof being blocked. Further, the positions of the synchronous deviation detection lights 111 to 114 do not need to be finely adjusted as long as the synchronous deviation detection lights 111 to 114 are disposed at positions out of and close to the view ranges.

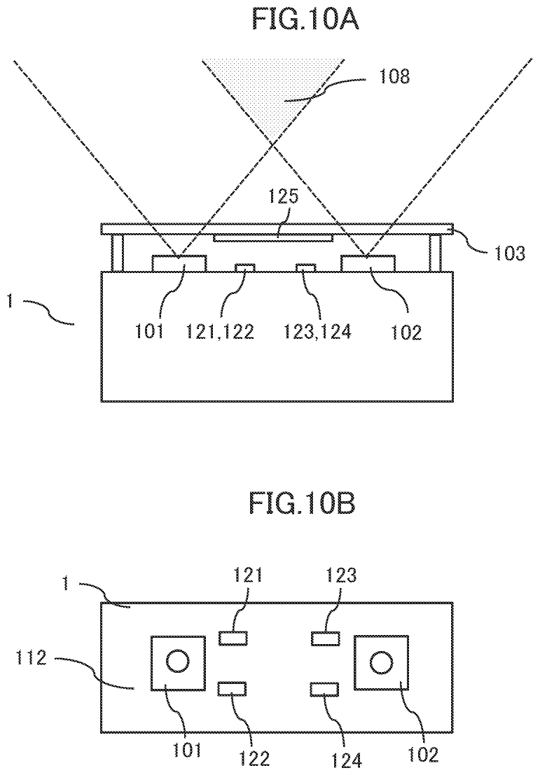

Alternatively, as a modification example of the present embodiment, the following configuration can be considered. As illustrated in FIGS. 10A and 108, synchronous deviation detection lights 121 to 124 are disposed on the front side of the stereo camera 1, and a diffusion plate 125 is disposed on the camera side of the illumination board 103, that is, on the back surface of the illumination board 103. The synchronous deviation detection lights 121 to 124 radiate light onto the diffusion plate 125. In this case, the size and shape of the diffusion plate 125 is set such that the irradiation range of diffused light covers the lenses of the monocular cameras 101 and 102. Also according to such a configuration, an image in which a lens flare occurs can be captured by causing stray light in the lens barrels of the monocular cameras 101 and 102 by emitting light from the synchronous deviation detection lights 121 to 124 as described above, and synchronization can be performed by using a method similar to that described above.

As described above, according to the configuration in which the synchronous deviation detection lights 121 to 124 are disposed on the camera and the diffusion plate 125 is used, the optical path length from the synchronous deviation detection lights 121 to 124 to the monocular cameras 101 and 102 can be doubled. Therefore, the irradiation range of the diffused light from the diffusion plate 125 can be wide even in the case where the illumination board 103 is close to the monocular cameras 101 and 102. As a result of this, the illumination board 103 can be disposed at a position close to the monocular cameras 101 and 102, and therefore the size of the structure around the stereo camera 1 can be reduced.

### Fourth Embodiment

In the first and third embodiments described above, the synchronous deviation detection lights are incorporated in the unit of the stereo camera 1. Therefore, the size of the unit of the stereo camera 1 can be large and the cost thereof can be high.

In the present embodiment, a configuration example in which the size and weight of the unit portion of the stereo camera 1 can be relatively reduced by using a recursion reflection material will be described. In addition, in the present embodiment, a configuration that is advantageous in the case of using the stereo camera 1 as a vision system of a robot apparatus will be described. This robot apparatus is disposed in a manufacturing line or a manufacturing system for manufacturing a product such as an industrial product from a workpiece together with the stereo camera 1. The stereo camera 1 can be used for, for example, performing three-dimensional measurement on a workpiece or the like handled by the robot apparatus. For example, the operation of the robot apparatus can be controlled on the basis of three-dimensional information including the depth and so forth of a mounting portion of the workpiece obtained by three-dimensional measurement by the stereo camera 1.

In the description below, part of the configuration of the hardware and control system different from the first embodiment will be illustrated and described, and detailed description of part similar to the first embodiment will be omitted assuming that the part can be configured in a similar manner as described above and can have a similar effect.

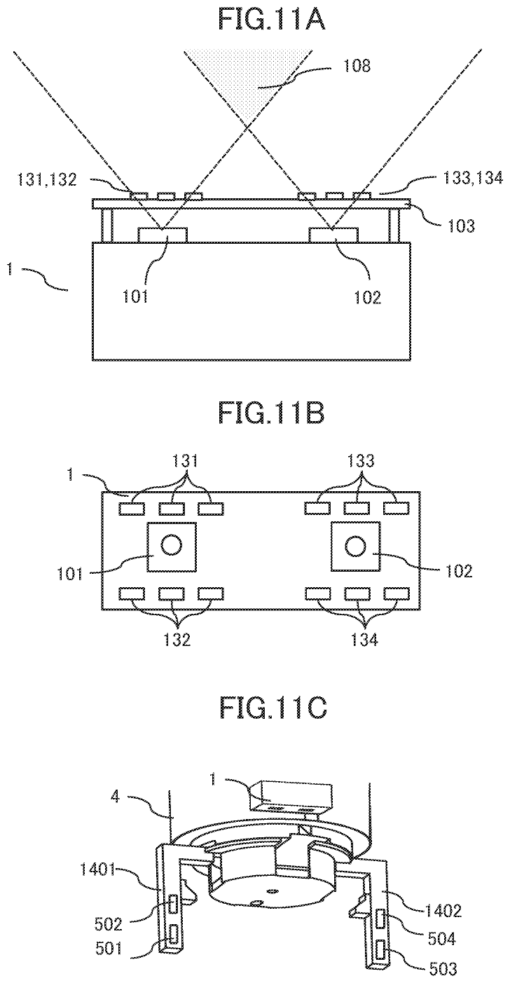

In the present embodiment, as illustrated in FIGS. 11A and 11B, synchronous deviation detection lights 131 to 134 are disposed on the front surface of the illumination board 103. The irradiation directions of the synchronous deviation detection lights 131 to 134 are opposite to directions oriented toward the monocular cameras 101 and 102. That is, in the present embodiment, the synchronous deviation detection lights 131 to 134 radiates illumination light toward a measurement target object. In addition, as illustrated in FIG. 11B, the synchronous deviation detection lights 131 and 132 are disposed in the vicinity of the monocular camera 101, and the synchronous deviation detection lights 133 and 134 are disposed in the vicinity of the monocular camera 102. In addition, as illustrated in FIG. 11B, the synchronous deviation detection lights 131 and 133 are disposed on the upper side of the monocular cameras 101 and 102, and the synchronous deviation detection lights 132 and 134 are disposed on the lower side of the monocular cameras 101 and 102. The driving power lines of the synchronous deviation detection lights 131 and 133 are electrically connected to each other, and the synchronous deviation detection lights 131 and 133 can be turned on/off simultaneously. The driving power lines of the synchronous deviation detection lights 132 and 134 are electrically connected to each other, and the synchronous deviation detection lights 132 and 134 can be turned on/off simultaneously.

As illustrated in FIG. 11C, the stereo camera 1 of the present embodiment is attached to a robot hand 4 of a robot apparatus. According to such a configuration, for example, the position and orientation of the robot hand 4 of the robot apparatus can be controlled on the basis of the result of three-dimensional measurement of a measurement target object obtained by the stereo camera 1.

The robot hand 4 includes fingers 1401 and 1402 as gripping devices, and the fingers 1401 and 1402 can grip the measurement target object. Further, in the present embodiment, a recursion reflection mark 501 is attached to a distal end portion of the finger 1401, and a recursion reflection mark 502 is attached to a middle portion of the finger 1401. Similarly, a recursion reflection mark 503 is attached to a distal end portion of the finger 1402, and a recursion reflection mark 504 is attached to a middle portion of the forger 1402. The recursion reflection marks 501 to 504 can be formed from a plastic material or the like, and these can be attached by arbitrary methods such as screwing and adhesion.

The relative positional relationship between the recursion reflection marks 501 to 504 and the stereo camera 1 determined on the basis of the attachment positions of the recursion reflection marks 501 to 504 and the installation position of the stereo camera 1 is determined such that the recursion reflection marks 501 to 504 are included in the common view range 108 of the stereo camera 1.

The synchronous deviation detection lights 131 to 134 are preferably constituted by illumination light sources having high directionality. For example, illumination light from the synchronous deviation detection light 131 is configured to irradiate only the recursion reflection mark 501 and the vicinity thereof. Similarly, illumination light from the synchronous deviation detection lights 132, 133, and 134 is configured to respectively irradiate only the recursion reflection marks 502, 503, and 504 and the vicinity thereof

As described above, if the synchronous deviation detection lights 131 to 134 are disposed in the vicinity of the monocular cameras 101 and 102, the reflection light from the recursion reflection marks 501 to 504 is incident on the monocular cameras 101 and 102.

For example, in the case where images are captured by the monocular cameras 101 and 102 while the synchronous deviation detection lights 131 and 133 are on, images in which only the vicinity of the recursion reflection marks 501 and 503 are bright can be obtained. As described above, the brightness of a partial region of an image can be controlled, and therefore the synchronous deviation amount can be detected by using the method of step S16 illustrated in FIG. 4 described in the first embodiment.

According to the configuration described above, providing a light that radiates light toward the monocular cameras 101 and 102 while securing a certain optical path length is not necessary. To provide lights that emit light that is directly incident on the monocular cameras 101 and 102, the distance between the illumination board 103 and the monocular cameras 101 and 102 tends to be long. However, according to the present embodiment, such lights that emit light in such directions do not have to be employed, and therefore the unit of the stereo camera 1 can be more miniaturized.

To be noted, the illumination board 103 may be provided with an opening for securing the fields of view of the monocular cameras 101 and 102 or may be formed from a transparent material or the like. This also applies to the other embodiments described in this specification.

In addition, the synchronous deviation detection lights 131 to 134 may be also used as lights for three-dimensional measurement by the stereo camera 1. As a result of this, the monocular cameras 101 and 102 can be synchronized without providing a dedicated light, and therefore the stereo camera 1 can be manufactured at relatively low cost.

In the present embodiment, the stereo camera 1 is disposed on the robot hand 4, and therefore the relative positional relationship between the stereo camera 1 and the robot hand 4 does not change. That is, the recursion reflection marks 501 to 504 are in the common view range of the stereo camera 1 the whole time. To be noted, a configuration in which a recursion reflection mark is provided on the object such as a workpiece can be also considered. In such a configuration, in the case where there are a plurality of portions whose image is to be captured, a recursion reflection material needs to be provided for each portion whose image is to be captured. In contrast, according to the configuration in which the recursion reflection materials are provided on the robot hand 4, the man-hours for preparation for disposing the recursion reflection materials are reduced, and therefore the manufacturing system can be installed very easily.

To be noted, although the four recursion reflection marks 501 to 504 are provided in the present embodiment, the number of the recursion reflection marks can be arbitrarily selected, and can be increased or reduced in accordance with required image capturing specifications. For example, one recursion reflection mark may be attached in a region that includes almost all of directions in which the common view range 108 extends, and synchronization may be performed by using the method described in the second embodiment by treating the reflection light from the recursion reflection mark in a similar manner to the illumination light from the synchronous deviation detection light of the second embodiment.

### Fifth Embodiment

In the first to fourth embodiments described above, particularly in the first embodiment, control using a random process in which one monocular camera is repeatedly switched to the power-off state 401 illustrated in FIG. 3 until the synchronous deviation amount becomes equal to or smaller than a predetermined value has been described. That is, the state of the one monocular camera is repeatedly switched from the power-off state 401 to the initializing state 402, the image capturing parameter adjusting state 403, and then the moving image outputting state 404 until the synchronous deviation amount becomes equal to or smaller than the predetermined value. The time taken until the synchronization is completed varies as a matter of probability. In addition, there is also a possibility that the synchronization does not settle quickly and it takes a long time that is practically problematic.

That is, according to the control described above, it may take a long time for the synchronization to be completed or the synchronization may not be completed, particularly in the case where the allowable range of the synchronous deviation amount that is determined in advance is narrow. That is, it is difficult to estimate the time required for the synchronization. In addition, as another issue, in the case where difference in the exposure period between the cameras is large, there is a possibility that the synchronous deviation occurs again when a long time elapses after synchronization is performed once, and the synchronous deviation amount increases as time passes.

In the present embodiment, a configuration in which the synchronous deviation is detected during three-dimensional measurement and an image pair with the least synchronous deviation is selected from images continuously output from the monocular cameras 101 and 102 in the moving image outputting state is considered to address the issue described above.

In the description below, part of the configuration of the hardware and control system different from the first embodiment will be illustrated and described, and detailed description of part similar to the first embodiment will be omitted assuming that the part can be configured in a similar manner as described above and can have a similar effect.

In the present embodiment, mainly a method of synchronization performed by selection of images will be described assuming that the configuration of the imaging system including a plurality of cameras, each constituent of the stereo camera 1, and each constituent of the image processing apparatus 2 are substantially the same as in the first to fourth embodiments.

The synchronous deviation amount is calculated by substantially the same method as in the first to fourth embodiments. To be noted, in the present embodiment, in the moving image outputting state of the monocular camera 102, images of a plurality of continuous frames including a target frame are stored on a memory without being deleted from a storage portion such as a memory or an image memory. The number of the plurality of continuous frames changes depending on the synchronous deviation amount, and the plurality of continuous frames include at least one frame before the target frame and at least one frame after the target frame.

### Method of Synchronization

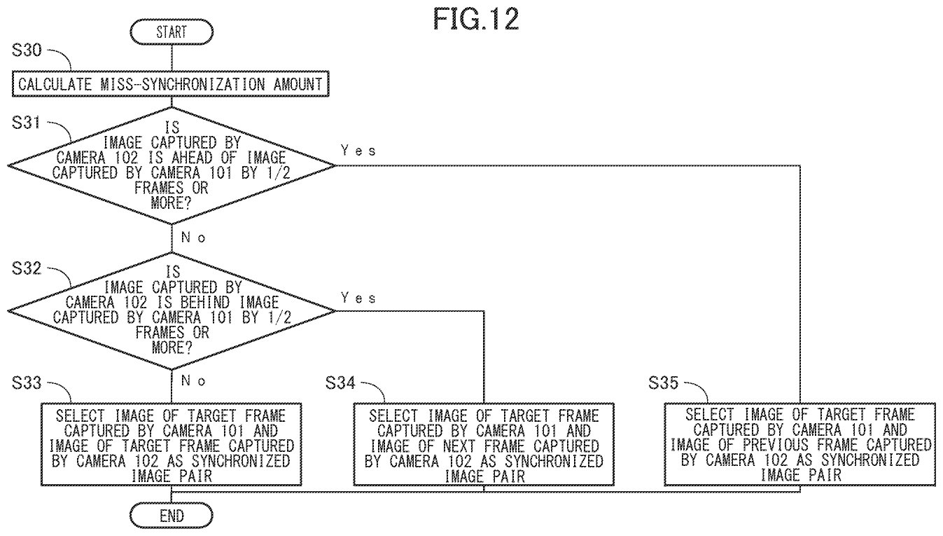

FIG. 12 illustrates a procedure of synchronization performed by selection of images in the present embodiment. In step S30 of FIG. 12, the synchronous deviation amount is calculated. In this step, the synchronous deviation amount is calculated by any one of the methods described in the embodiments above. To be noted, for the calculation of the synchronous deviation amount, among images captured by the monocular camera 102 during the moving image outputting state, images before and after the target from are stored on the memory.

In step S31, whether or not the synchronous deviation amount of the monocular camera 102 with respect to the monocular camera 101, which indicates how temporally ahead the monocular camera 102 is with respect to the monocular camera 101, is +½ frames or positively greater is determined. For example, in the case where the frame rate of the monocular cameras 101 and 102 is 25 fps, that is, 0.04 second per frame, whether or not the synchronous deviation amount of the monocular camera 102 with respect to the monocular camera 101 is +0.02 or positively greater is determined. In the case where the synchronous deviation amount is +½ frames or positively greater, that is, in the case where the result of step S31 is YES, the process proceeds to step S35. In addition, in the case where the synchronous deviation amount is not equal to or positively greater than +½ frame, that is, in the case where the result of step S31 is NO, the process proceeds to step S32.

In step S32, whether or not the synchronous deviation amount of the monocular camera 102 with respect to the monocular camera 101 is −½ frames or negatively greater is determined. For example, in the case where the frame rate of the monocular cameras 101 and 102 is 25 fps, whether or not the synchronous deviation amount of the monocular camera 102 with respect to the monocular camera 101 is −0.02 or negatively greater is determined. In the case where the synchronous deviation amount is −½ frames or negatively greater, that is, in the case where the result of step S32 is YES, the process proceeds to step S34. In addition, in the case where the synchronous deviation amount is not equal to or negatively greater than −½ frame, that is, in the case where the result of step S32 is NO, the process proceeds to step S33.

In step S33, an image of the target frame captured by the monocular camera 101 and an image of the target frame captured by the monocular camera 102 are selected as a synchronized image pair. In step S34, an image of the target frame captured by the monocular camera 101 and an image of a next frame captured by the monocular camera 102 are selected as a synchronized image pair. In step S35, an image of the target frame captured by the monocular camera 101 and an image of a previous frame captured by the monocular camera 102 and stored on the memory are selected as a synchronized image pair.

Regarding steps S33, S34, and S35, a time difference between a time point when an image used for detecting the synchronous deviation among a plurality of images captured by the monocular camera 101 is captured and a time point when an image captured by the monocular camera 101 selected for the synchronization, that is, one of the image pair, is captured is set as Δf1. In addition, time difference between a time point when an image used for detecting the synchronous deviation among a plurality of images captured by the monocular camera 102 is captured and a time point when an image captured by the monocular camera 102 and selected for the synchronization, that is, another of the image pair, is captured is set as Δf2. In step S33, Δf1 can be equal to Δf2. However, in steps S34 and S35, Δf1 can be different from Δf2. For example, in steps S34 and S35, there is one-frame difference between Δf1 and Δf2.

In the description above, a synchronization method applicable to a case where the synchronous deviation amount between the monocular cameras 101 and 102 is 1 frame or less has been described. However, in the case where the synchronous deviation amount between the monocular cameras 101 and 102 is greater than 1 frame, for example, the frame is shifted by using an integer part of the synchronous deviation amount [frame]. Then, the images to be used can be selected in a manner similar to that described above by using a decimal part of the synchronous deviation amount based on the image of the frame to which the frame has been shifted.

For example, it is assumed that the monocular camera 102 is temporally ahead of the monocular camera 101 by 2.4 frames. In this case, an image 2 frames before the image of the target frame captured by the monocular camera 102 is set as the reference, and determination is made in step S31 by using 0.4 frames as the synchronous deviation amount. Then, since the synchronous deviation amount is not equal to or positively greater than ½ frames, the process proceeds to the determination of step S32. In the determination of step S32, since the synchronous deviation amount is not equal to or negatively greater than −½ frames, the process proceeds to step S33, and an image pair is selected by using the image that is 2 frames before the image of the target frame as the reference. In this case, as a result, an image of the target frame captured by the monocular camera 101 and an image 2 frames before an image of the target frame captured by the monocular camera 102 are selected as an image pair. In this case, there is a 2-frame difference between Δf1 and Δf2.

By setting an appropriate image pair, the time difference between time points at which the two images to be used for image processing such as three-dimensional measurement are respectively captured becomes smaller than time difference between time points at which the two images used for image processing for detecting the synchronous deviation. The temporal separation in terms of frames between the images to be selected as a pair used for three-dimensional measurement as described above can be determined in advance, for example, before the three-dimensional measurement or while the three-dimensional measurement is not performed. That is, as an image captured by the monocular camera 102 to be paired up with an image of a target frame captured by the monocular camera 101, which of an image of the target frame captured by the monocular camera 102, an image of a previous frame captured by the monocular camera 102, and an image of a next frame captured by the monocular camera 102 is to be used is determined in advance. Alternatively, the synchronization may be performed for each three-dimensional measurement to determine a frame to be used as the image captured by the monocular camera 102 to be paired up with the image captured by the monocular camera 101.

To be noted, although a frame to be used as the image captured by the monocular camera 102 to be paired up with the image captured by the monocular camera 101 is determined in the present embodiment, conversely, a frame to be used as an image captured by the monocular camera 101 to be paired up with an image captured by the monocular camera 102 may be determined. In addition, the control of switching the camera serving as the standard in accordance with various conditions related to three-dimensional measurement may be performed.

In addition, the synchronization according to the present embodiment is generally applicable to synchronization of a plurality of cameras. However, in the case of lighting up a synchronous deviation detection light during the three-dimensional measurement of the present embodiment, each monocular camera of the stereo camera 1 is preferably constituted by a global shutter camera. In the case of applying the synchronization according to the present embodiment to a stereo camera constituted by rolling shutter cameras, a line corresponding to a timing when an image of illumination light is captured appears as a bright belt, which serves as a noise in an image to be used for measurement. Therefore, the three-dimensional measurement might be hindered. By using global shutter cameras as described above, the influence of synchronization light on three-dimensional measurement can be reduced.

Alternatively, in the case where a stereo camera constituted by rolling shutter cameras is used and a synchronous deviation detection light is lighted up during three-dimensional measurement, the following configuration may be employed. For example, disposing the synchronous deviation detection light in a region not used for three-dimensional measurement, which is out of the common view range of the monocular cameras 101 and 102, as in the first embodiment can be considered. According to such a configuration, the synchronization of the image capturing timing can be performed without hindering the three-dimensional measurement by the synchronous deviation detection light.

According to the configuration in which a frame image to be used for three-dimensional measurement is selected on the basis of the magnitude of the synchronous deviation amount as in the present embodiment, the time required for the synchronization to be completed is not a matter of probability. The time required for the synchronization to be completed can be shortened and kept constant. In addition, the synchronization can be also executed for each three-dimensional measurement, and therefore an effect that synchronous deviation does not occur even in the case where the measurement is continued for a long period can be expected.

### Sixth Embodiment

Although the stereo camera 1 is constituted by the two monocular cameras 101 and 102 in the first to fifth embodiments described above, using three or more cameras can be also considered. If a monocular camera is provided additionally to the two cameras used for three-dimensional measurement, for example, the synchronous deviation amount between the two cameras during the three-dimensional measurement can be monitored, and the pair or combination of monocular cameras used for three-dimensional measurement can be switched. As the timing to switch the combination of monocular cameras used for three-dimensional measurement, a timing at which the synchronous deviation amount of two cameras being used for three-dimensional measurement becomes large can be considered. In addition, control in which the pair or combination of monocular cameras used for three-dimensional measurement is switched regularly can be also considered. In this case, for example, two pairs of the monocular cameras 101 and 102 are prepared as will be described later, and control in which synchronous deviation detection and synchronization based on the synchronous deviation detection are performed by one pair while the other pair is performing three-dimensional measurement can be performed.

In the first to fifth embodiments described above, in the case where the difference in the exposure period between the monocular cameras 101 and 102 is large, there is a possibility that synchronous deviation occurs again when a long time elapses after synchronization is performed once, and the synchronous deviation amount increases as time passes. In addition, in some layout of synchronous deviation detection lights, the three-dimensional measurement needs to be stopped for performing synchronization again in the case where the cameras are miss-synchronized. According to the present embodiment, the issues described above can be addressed by using three or more monocular cameras.

In the description below, part of the configuration of the hardware and control system different from the first embodiment will be illustrated and described, and detailed description of part similar to the first embodiment will be omitted assuming that the part can be configured in a similar manner as described above and can have a similar effect.

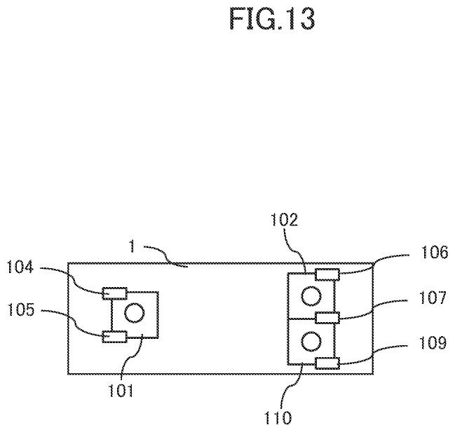

As illustrated in FIG. 13 as an example, in the present embodiment, the stereo camera 1 includes three monocular cameras 101, 102, and 110. FIG. 13 illustrates the configuration of the stereo camera 1 in a similar manner to FIG. 1B. The monocular cameras 101 and 102 are arranged so as to be separated from each other by a predetermined base line length similarly to the first embodiment. The monocular cameras 101, 102, and 110 are arranged such that the base line length between the imaging optical systems of the monocular cameras 101 and 110 is equal to the base line length between the monocular cameras 101 and 102.

Further, synchronous deviation detection lights 104 to 107 and 109 are disposed in correspondence with the monocular cameras 101, 102, and 110 as illustrated in FIG. 13. The synchronous deviation detection light 107 are disposed between the monocular cameras 102 and 110 such that the synchronous deviation detection light 107 can be used for both of the monocular cameras 102 and 110.

According to such a configuration, for example, the synchronous deviation amount between the monocular cameras 101 and 102 performing the three-dimensional measurement can be monitored, and when synchronous deviation occurs, the combination of cameras used for three-dimensional measurement can be switched. For example, the combination of cameras used for three-dimensional measurement is switched from a first combination including the monocular cameras 101 and 102 to a second combination including the monocular cameras 101 and 110. According to such a configuration, the synchronization can be performed in parallel with the three-dimensional measurement without delaying the three-dimensional measurement.

Conversely, the synchronous deviation amount between the monocular cameras 101 and 110 can be monitored while the three-dimensional measurement is performed by the monocular cameras 101 and 110. Then, when synchronous deviation occurs, the cameras used for three-dimensional measurement are switched to the monocular cameras 101 and 102. As a result of this, measurement can be continued with the monocular cameras 101 and 102. In this manner, the role of two cameras in a stereo imaging system can be alternately switched between three-dimensional measurement and synchronization, and thus the three-dimensional measurement can be continued by a stereo imaging system that is always synchronized without stopping or delaying the three-dimensional measurement.

### Method of Switching Measurement Cameras

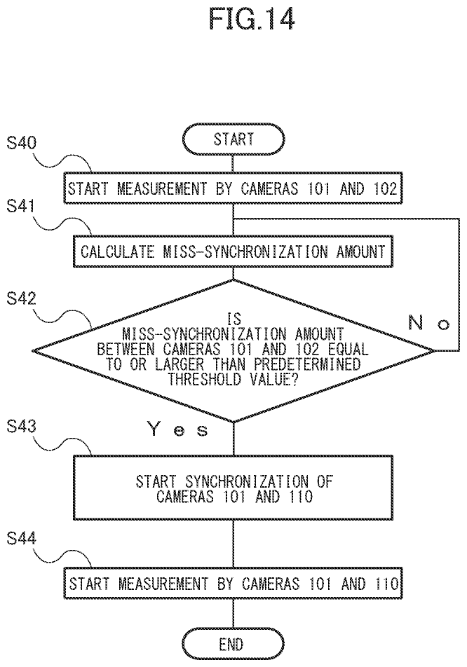

FIG. 14 illustrates a specific example of control of switching the monocular cameras 101, 102, and 110 constituting two stereo imaging systems. FIG. 14 illustrates an example of a camera switching control procedure.

In step S40 of FIG. 14, three-dimensional measurement is started by the monocular cameras 101 and 102. In step S41, the synchronous deviation amount between the monocular cameras 101 and 102 is calculated. As a method of calculating the synchronous deviation amount, a method substantially the same as the method of the first embodiment using the synchronous deviation detection lights 104 to 107 can be used.

In step S42, whether or not the synchronous deviation amount between the monocular cameras 101 and 102 is equal to or larger than a predetermined threshold value is determined. In the case where the synchronous deviation amount between the monocular cameras 101 and 102 is smaller than the threshold value, that is, in the case where the result of step S42 is NO, the process returns to step S41, and the synchronous deviation amount is checked again. In addition, in the case where the synchronous deviation amount between the monocular cameras 101 and 102 is equal to or larger than the threshold value, that is, in the case where the result of step S42 is YES, the process proceeds to step S43.

In step S43, synchronization of the monocular cameras 101 and 110 is started. This synchronization processing can be performed by a method of, for example, repeatedly switching the state of the monocular camera 110 from the power-off state to the initializing state, then to . . . until the synchronous deviation amount becomes equal to or smaller than a predetermined value as in the first embodiment. Alternatively, the synchronization of the monocular cameras 101 and 110 may be performed by a different method described above.

In step S44, the imaging system used for three-dimensional measurement is switched to the monocular cameras 101 and 110, and the three-dimensional measurement is started. That is, cameras used for the three-dimensional measurement are switched from the monocular cameras 101 and 102 to the monocular cameras 101 and 110. Then, steps S41 to S44 are repeated while switching the cameras whose synchronous deviation amount is monitored and cameras subjected to synchronization until desired three-dimensional measurement is finished.

Although an example in which the stereo camera 1 is constituted by three monocular cameras has been described above, the stereo camera I may be constituted by more monocular cameras. For example, four or more monocular cameras may be used, and an imaging system whose synchronous deviation amount is calculated and an imaging system subjected to synchronization may be switched. Such a configuration in which the imaging system whose synchronous deviation amount is calculated and the imaging system subjected to synchronization are caused to operate in parallel has a great merit. For example, while an imaging system of some cameras is performing three-dimensional measurement, synchronization can be performed in parallel on an imaging system of other monocular cameras. According to this configuration, for example, in the case where it is required to switch the imaging system for three-dimensional measurement, the processing time for the synchronization processing illustrated in FIG. 14 is not required, and switching to an imaging system that has been already synchronized can be performed at high speed.

To be noted, the positional relationship in the horizontal direction between the monocular cameras 102 and 110 and the monocular camera 101 illustrated in FIG. 13 may be different from that illustrated in FIG. 13. For example, a layout in which the monocular cameras 101, 102, and 110 are arranged on a straight line with the monocular camera 101 in the middle can be considered, or the three monocular cameras may be arranged at respective apices of an equilateral triangle such that the interval therebetween is constant. In addition, in the description above, a pair of the monocular cameras 101 and 102 or a pair of the monocular cameras 101 and 110 is used for three-dimensional measurement. However, depending on the layout of the monocular cameras, a pair of the monocular camera 102 and 110 may be used for measurement.

The configurations of embodiments described above are mere examples, and the design thereof can be modified in various ways by one skilled in the art within the concept of the present embodiment. For example, in the description above, the plurality of monocular cameras that perform synchronized image capturing constitute a stereo camera for three-dimensional measurement. However, it is needless to say that the hardware configuration and image capturing control of these embodiments can be also implemented in an imaging system that is constituted by a plurality of monocular cameras and needs to perform synchronized image capturing for some purpose. For example, in the case of creating a three-dimensional moving image such as a free-viewpoint image, since synchronized image capturing is performed by a plurality of cameras, applying an embodiment described above to detect synchronous deviation is effective for improvement in the quality of the moving image created by the synchronized image capturing. In addition, also in the case of performing synchronized image capturing by a plurality of cameras incorporated in an image capturing device such as a smartphone, applying an embodiment described above to detect synchronous deviation is effective for improvement in the quality of the moving image created by the synchronized image capturing.

To be noted, any light source may be used for a light image of an object in images used for synchronous deviation detection as long as an image of illumination light thereof can be captured by the monocular cameras 101 and 102. That is, the illumination light is not limited to illumination light of an illumination device included in an imaging system, and may be illumination light of an illumination device outside the imaging system. Illumination light can be also radiated at a predetermined timing by blocking natural light at a predetermined light-blocking timing. In addition, a configuration in which the stereo camera 1 of the embodiments described above is provided on the robot hand 4 has been described, the configuration is not limited to this. The embodiments described above are applicable to machines capable of automatically performing operations such as extension, contraction, bending, vertical movement, horizontal movement, rotation, or a combination of these on the basis of information stored in a storage device provided in a controller.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-107619, filed Jun. 23, 2020, which is hereby incorporated by reference herein in its entirety.

What is claimed is:

1. An imaging system comprising:
a plurality of cameras; and
a controller,
wherein the controller detects synchronous deviation of image capturing timing of the plurality of cameras by using images respectively captured by the plurality of cameras.

2. The imaging system according to claim 1, wherein the controller is configured to detect the synchronous deviation by calculating an amount based on a difference between a first time point and a second time point and determining whether or not the amount is equal to or smaller than a predetermined value, the amount being calculated by using a first image captured by a first camera at the first time point and a second image captured by a second camera at the second time point, the plurality of cameras comprising the first camera and the second camera.

3. The imaging system according to claim 1, wherein the controller is configured to synchronize the plurality of cameras on a basis of the detected synchronous deviation.

4. The imaging system according to claim 3, wherein the synchronizing comprises changing an image capturing timing of one of the plurality of cameras.

5. The imaging system according to claim 4, wherein the changing comprises initializing the one of the plurality of cameras or switching off the one of the plurality of cameras.

6. The imaging system according to claim 1, wherein the plurality of cameras constitute a stereo camera configured to obtain three-dimensional information of an object.

7. The imaging system according to claim 1, further comprising an illumination apparatus configured to radiate, at a predetermined light-emitting timing, illumination light under which the plurality of cameras are capable of performing image capturing, wherein the images used for detection of the synchronous deviation comprise a light image formed by the illumination light.

8. The imaging system according to claim 7, wherein a light-emitting member constituting the illumination apparatus is attached to a casing that positions the plurality of cameras with respect to one another.

9. The imaging system according to claim 7, wherein a radiation direction of a light-emitting member constituting the illumination apparatus comprises a radiation direction oriented toward an imaging optical system of the plurality of cameras.

10. The imaging system according to claim 7, wherein the illumination apparatus comprises a plurality of light-emitting members whose driving power source lines are connected to each other and radiate the illumination light at a predetermined light emitting timing.

11. The imaging system according to claim 7, wherein a response time of a light-emitting member constituting the illumination apparatus to drive control is shorter than an image capturing control time of the plurality of cameras.

12. The imaging system according to claim 7, wherein the illumination apparatus is disposed outside a common view range of the plurality of cameras and inside individual view ranges of the plurality of cameras.

13. The imaging system according to claim 7, wherein the illumination apparatus is disposed at a position outside all view ranges of the plurality of cameras such that an irradiation range thereof includes the plurality of cameras.

14. A manufacturing system comprising:
the imaging system according to claim 1;
a robot apparatus configured to handle a workpiece;
and a robot controller configured to control the robot apparatus on a basis of three-dimensional information of the workpiece obtained by the plurality of cameras of the imaging system.

15. The manufacturing system according to claim 14, wherein a recursion reflection material that reflects illumination light radiated from an illumination apparatus is attached to a gripping device of the robot apparatus, images of the illumination light reflected by the recursion reflection material is captured by the plurality of cameras, and the controller performs image processing on the images of the reflected illumination light to detect the synchronous deviation of image capturing timing of the plurality of cameras.

16. An imaging method using a plurality of cameras comprising a first camera and a second camera, the imaging method comprising:
obtaining a first image captured by the first camera at a first time point and a second image captured by the second camera at a second time point;
performing first image processing using the first image and the second image;
obtaining a third image captured by the first camera at a third time point and a fourth image captured by the second camera at a fourth time point, the third time point and the fourth time point being later than a time point at which the first image processing is performed; and
performing second image processing using the third image and the fourth image,
wherein a difference between the third time point and the fourth time point is smaller than a difference between the first time point and the second time point.

17. The imaging method according to claim 16, wherein a difference between the first time point and the third time point is different from a difference between the second time point and the fourth time point.

18. The imaging method according to claim 16, wherein three-dimensional information of an object is obtained by the second image processing.

19. The imaging method according to claim 16, wherein, in the first image processing, synchronous deviation of image capturing timing of the plurality of cameras is detected on a basis of brightness patterns in images respectively captured by the plurality of cameras.

20. The imaging method according to claim 16, wherein, in the first image processing, synchronous deviation of image capturing timing of the plurality of cameras is detected on a basis of positions of an object in images respectively captured by the plurality of cameras.

21. The imaging method according to claim 16, wherein, in the first image processing, synchronous deviation of image capturing timing of the plurality of cameras is detected on a basis of a ratio of brightness of images respectively captured by the plurality of cameras.

22. The imaging method according to claim 16, wherein the plurality of cameras comprise three or more cameras, and the imaging method comprises monitoring synchronous deviation between the first camera and the second camera via the first image processing.

23. A method for manufacturing a product, the method comprising:
controlling a robot apparatus by a robot controller on a basis of information of a workpiece obtained by the imaging method according to claims 16; and
manufacturing a product from the workpiece by handling the workpiece by the robot apparatus.

24. A non-transitory computer-readable recording medium storing the control program that causes a computer to execute the imaging method according to claim 16.
